(19) United States
(12) Patent Application Publication
(10) Pub. No.: US 2012/0091877 A1
(43) Pub. Date: Apr. 19, 2012

(54) ORGANIC LIGHT EMITTING DIODE FOR LIGHT-INDUCED PATTERNING WITH BUCKLING RESISTING PROPERTIES

(75) Inventor: Coen Adrianus Verschuren, Eindhoven (NL)

(73) Assignee: KONINKLIJKE PHILIPS ELECTRONICS N.V., EINDHOVEN (NL)

(21) Appl. No.: 13/260,811

(22) PCT Filed: Mar. 25, 2010
(86) PCT No.: PCT/IB10/51308

§ 371 Date: Dec. 28, 2011

(30) Foreign Application Priority Data
Apr. 2, 2009 (EP) 09157184.4

(51) Int. Cl. H01J 1/02; H05B 33/14

(52) U.S. Cl. 313/46; 313/504

(57) ABSTRACT

An organic light emitting diode (OLED) (100) for light-induced patterning is presented. The OLED comprises a buckling-reducing layer (150) connected to a cathode layer (140) at a side of the cathode layer facing away from a light emitting layer (130). The buckling reducing layer is configured for improving a resistance to buckling resulting from local heating of the cathode, which heat may be caused by patterning the OLED. The buckling reducing layer improves mechanical properties, e.g., stiffness, and/or thermal properties, e.g. through cooling, of the cathode.

### FIELD OF THE INVENTION

The invention relates to an OLED comprising a stack of layers, the stack comprising a light emitting layer arranged between a cathode layer and an anode layer, the stack being arranged on a substrate.

The invention further relates to a patterned OLED and to a light source.

### BACKGROUND OF THE INVENTION

An organic light emitting diode, also referred to as OLED, typically comprises a cathode, an anode and a light emitting layer. These layers can be stacked on a substrate. The OLED may also comprise conductive layers. The light emitting layer may be manufactured of organic material that can conduct an electric current. When a voltage is applied across the cathode and anode, electrons travel from the cathode towards the anode. Furthermore, holes are created in the conductive layer at the anode side. When electrons and holes recombine, photons are emitted from the organic LED device. Organic LED devices are in many ways considered as the future in various lighting applications.

Patent application ‘Device, method and system for lighting,’ with attorney docket PH009044, incorporated herein by reference, describes an organic LED device. The organic LED device displays, when in use, a predetermined pattern on its light emitting parts. The organic LED device comprises an anode, a cathode, and an organic light emitting layer. The organic light emitting layer is configured to emit light. Part of the organic light emitting layer stack has been irradiated by light with a wavelength in the absorption band of the organic light emitting layer. The light intensity of the irradiating light is below an ablation threshold of the cathode layer, the anode layer and the organic light emitting layer. As a result of the irradiation treatment that part of the light emitting layer stack has reduced light emitting properties.

By selecting which parts of the light emitting layer to treat, and for how long, an image may be imprinted in the OLED. Patterned OLEDs may, for instance, be used to create ambient lighting. Full 2-dimensional grayscale pictures can be made in a single organic LED device, while maintaining all intrinsic advantages of organic LED devices, for instance, being appealing, being a diffuse area light source and so on.

### SUMMARY OF THE INVENTION

During the patterning typically a condensed light beam, such as a laser, is used. The laser has an intensity which is relatively high such that at a location in the light emitting layer stack that is irradiated with light, the OLED will heat up. To avoid deformation of the OLED, the irradiation-induced temperature in the OLED should stay below a deformation threshold. Patterning an OLED requires careful calibration and control of the laser intensity, as well as the scanning speed in order to get high contrast patterning without causing unwanted deformation of the metal electrode in the device, i.e., buckling. Especially the cathode layer is sensitive to buckling.

Moreover, in order to speed up the production of light-induced patterned OLEDs it is desired to increase the intensity of the patterning light. When the OLED is heated, parts of the OLED may deform and eventually buckle.

To better address this concern, in a first aspect of the invention an OLED for light-induced patterning is presented. The OLED comprises a stack of layers. The stack comprising at least a light emitting layer arranged between a cathode layer and an anode layer. The stack is arranged on a substrate. The OLED further comprises a buckling-reducing layer, not-being the substrate. The buckling-reducing layer is connected to the cathode at a side of the cathode layer facing away from the light emitting layer. The buckling-reducing layer is configured for improving a resistance to buckling resulting from local heating of the cathode.

The OLED for light-induced patterning according to the invention has the advantage that it can be patterned with light in a more cost-effective manner.

In the known system, when light is applied at some point of the light emitting layer stack to reduce the light emitting properties at that point, then the light will also heat the cathode layer. If the intensity of the light is high enough, then at some point the cathode layer will reach a temperature, at which it buckles.

However in the OLED according the invention, the cathode is connected to a buckling-reducing layer, which increases the cathode's resistance to bucking. Even if a cathode layer were used of the same material and thickness as in the known system, then the cathode layer would be able to withstand buckling better.

Since the buckling-reducing layer is applied to a side of the cathode which faces away from the light-emitting layer, the light-emitting properties of the light-emitting layer are not impaired.

Because of the buckling-reducing layer, the intensity of light which is used to induce a pattern in the OLED may be increased. As a result less time is required at one point of the OLED to reduce the light emitting property of the light emitting layer stack. The scanning speed, with which the laser scans over the surface of the OLED during the patterning, can be therefore be increased. That is, if less time is required for any particular point of the OLED to achieve the desired altering of the light emissive properties then also less time is required to apply the whole pattern. Accordingly, the time for pattering the OLED is reduced. A shorter patterning phase during manufacture of a patterned OLED implies a corresponding shortening of the manufacture time of the patterned OLED.

It is also possible to divide the scanning phase into multiple scanning passes. The reduction in the light emissive properties may then proceed in several distinct steps. This has the advantage that heat which is build up during a first pass can dissipate before the second pass starts. In this way buckling is avoided. When multiple scanning passes are used to pattern the OLED according to the invention, then fewer passes may suffice. Since the cathode layer has a higher resistance to buckling, the intensity of the laser used in any one of the multiple passes can be higher and fewer passes are needed. Fewer scanning passes reduce the time the patterning phase takes.

The manufacture time needed to fabricate a patterned OLED makes an important contribution to the cost price of a patterned OLED. To reduce cost-price, increased patterning speeds are therefore of advantage.

A further advantage of using higher intensity light during the patterning is that the contrast in the pattern which may be achieved in a single pass is increased. A higher intensity light source can achieve a stronger reduction of the light emissive properties of the light emissive layer. Accordingly, a larger difference between darkened parts of the OLED and parts which are left untreated can be accomplished.

An OLED according to the invention may be used with various light-induced patterning methods. As a first example, the light emitting layer may comprise oligomers and/or polymers and be patterned with a method which influences those materials. As a further example, the stack and/or the light emitting layer may comprise a working layer, such as a current support layer. In that case, the light induced patterning can affect its current supporting properties, so as to effect a reduced potential for current flowing through the light-emitting layer. If the potential for current flowing through the light-emitting layer is reduced, then the light emitting properties are correspondingly reduced. It is noted, that in both examples, the light used will at least to some extent heat the cathode layer. Accordingly, in both examples a buckling-reducing layer will benefit the production process.

The higher resistance to buckling of the cathode layer may materialize in at least two different ways.

First of all, an OLED may have a higher resistance to buckling of the cathode layer by delaying the onset of the buckling. That is, by an increased buckling threshold of the cathode layer. The buckling threshold defining an amount of heat energy above which buckling of the cathode layer occurs, if said amount is applied to the cathode layer during the light-induced patterning.

By increasing the buckling threshold the intensity of the light can be increased, while avoiding buckling all together. Especially for cathode layers made from fragile materials, e.g., transparent cathode layers, staying under the buckling threshold is preferred. Compared to an OLED without a buckling reducing layer, the buckling would start after more heat-energy has been applied, since the buckling layer, e.g., withstands the buckling due to its stiffness, or because it assists in handling the incoming heat energy. Higher light intensities can be used without buckling.

A second way in which an OLED may have a higher resistance to buckling is by mitigating the severity of the buckling after its onset. When buckling of the cathode layer has started but the application of heat continues, the buckling becomes increasingly severe. The severity shows, e.g., through higher and/or sharper folds of the material. However, for some applications, a certain amount of buckling can be tolerated as long as the buckling stays under predetermined limits. Particularly, the buckling should not progress to the point where the cathode ablates. A buckling reducing layer can slow the rate at which the buckling of the cathode layer progresses. Moreover, it reduces the visibility of the buckling.

In a preferred embodiment, the connection between the buckling-reducing layer and the cathode layer comprises a mechanical connection for increasing a mechanical stiffness level of the cathode layer. A stiffer layer will be able to withstand higher light intensities, i.e., higher temperatures before buckling occurs.

Heating a part of the cathode layer during light-induced patterning causes stress in the material. When this stress is sufficiently high, buckling results. Having a mechanical connection between the cathode layer and the buckling resisting layer allows the cathode to withstand a larger amount of stress. It is preferred to arrange the buckling-reducing layer to have a higher mechanical stiffness level than the cathode layer, for example, by selecting a suitable material or deposition method for the buckling-reducing layer. Having a buckling-reducing layer with a higher stiffness than the cathode layer, allows the buckling-reducing layer to be thinner. Preferably, the mechanical stiffness of the buckling-reducing layer is not lower than the mechanical stiffness level of the cathode layer. A thinner buckling-reducing layer can be applied, e.g., deposited, quicker, which reduces manufacture time of the OLED. The invention may be used in a cost effective production of OLEDS, which reduced manufacture times and reduced patterning times. Moreover, if the buckling reducing layer can be thinner than less material is required for the buckling reducing layer.

Preferably, the stiffness of the buckling-reducing layer extends in a direction parallel to the cathode layer for reducing buckling of the cathode layer.

Increasing the stiffness in a direction parallel to the cathode layer is effective to reduce buckling of the cathode layer. If the material resists movement in this direction, then the freedom of the cathode layer to wrinkle is correspondingly reduced.

In a preferred embodiment, the connection between the buckling-reducing layer and the cathode layer comprises a thermal connection for transporting heat from the cathode layer to at least part of the buckling-reducing layer.

The rate at which the buckling progresses after it has begun can be diminished by transporting away some of the heat caused in the cathode by the impinging light during the patterning. In this way, although heat continues to be supplied to the cathode, the severity of the buckling is limited.

In a preferred embodiment, the buckling reducing layer and the thermal connection to the cathode layer are configured to increase the buckling threshold by transporting heat to limit the local heating of the cathode layer during the light-induced patterning of the OLED. By transporting heat away from the cathode layer, the build-up of heat therein is prevented. Compared with the OLED without the buckling resisting layer, the onset of buckling will occur later, that is, after light has been applied for longer and/or after light of a higher intensity has been applied. Accordingly, light of a higher intensity may be used or light of the same intensity may be used for a longer time.

Better thermal conduction results in a lower temperature while the same light intensity is used for patterning. This allows a higher thermal load, i.e., amount of heat-energy, and consequently a higher light intensity.

In an embodiment according to the invention, the buckling-reducing layer and the thermal connection between the buckling-reducing layer and the cathode layer are configured to transport heat away from the cathode layer to a further heat sink. In this way, the capacity of the system formed by the cathode layer and the buckling reducing layer to handle inflow of heat is further increased. The heat-sink may be arranged in the OLED, but may also be arranged external to the OLED, and connected via a further thermal coupling. For example, a temporary heat-sink may be coupled to the buckling-reducing layer during the application of a pattern in the OLED using condensed light.

In a preferred embodiment, the buckling-reducing layer comprises a heat capacity for absorbing heat to limit the local heating of the cathode layer during the light-induced patterning of the OLED to increase the buckling threshold. Having a relatively high heat capacity enables the buckling-reducing to absorb a considerable amount of energy while the increase in temperature remains limited. During light-induced patterning, the heat capacity absorbs part of the heat that is applied to the cathode layer. In this way the buckling threshold is increased.

The buckling reducing layer in an OLED according to the invention may comprise materials whose material properties in semi-conductor and/or thin-film fabrication environments are well-understood. Such materials include various metals, including aluminum alloys, molybdenum, copper, and tungsten. Moreover, silicon is also well suited. Glass-like and ceramic materials are also possible, in particular solgel materials which can be applied in liquid form before curing. Preferably, the buckling reducing layer comprises at least one material out of the following list of materials: Aluminum Nitride, Silicium Nitride, SiNx:H, Aluminum Oxide, Aluminum oxynitride, silicon oxide or silicon oxynitride. The methods and equipment for applying coatings of these materials are commonly available.

In a preferred embodiment according to the invention, the cathode layer and the buckling reducing layer are at least partially transparent to visible light. When the cathode layer and the buckling reducing layer are transparent to visible light, the OLED can emit light in the direction of the cathode, possibly in addition to emitting light in the direction of the anode. Moreover, such an OLED can be at least partially transparent to visible light. In the latter case, the stack of layers, the substrate and the buckling-reducing layer are also at least partially transparent to visible light.

The cathode layer in a transparent OLED is typically a thin silver layer, e.g., 10 nm of silver. Such materials are especially sensitive to buckling. Because such materials are thinner they have a lower capacity for absorbing heat-energy. Also thin materials are damaged more easily. By applying a buckling reducing layer which is also transparent to light, the buckling in this type of OLED can be significantly reduced. Transparent buckling reducing layers may be fabricated from known materials, for example, the buckling-reducing layer may comprise at least one material out of the following list of materials: solgel, spin-on glass or epoxy, Aluminum Nitride, Silicium Nitride, SiNx:H, Aluminum Oxide, Aluminum oxynitride, silicon oxide or silicon oxynitride.

Transparent SiN and Transparent AlO, are preferably used in amorphous, non-crystalline form. Through the deposition technique their composition and structure can be varied, and consequently, their absorption.

In addition to or instead of visible light, the cathode layer and the buckling reducing layer may also be at least partially transparent to UV light and/or infrared light.

A further aspect of the invention concerns a patterned OLED according to the invention, wherein part of the light emitting layer has locally reduced light emitting properties constituting a pattern. Said patterned OLED comprises a stack of layers, the stack comprising a light emitting layer arranged between a cathode layer and an anode layer, the stack being arranged on a substrate. The patterned OLED further comprises a buckling-reducing layer, not-being the substrate or the cathode, the buckling-reducing layer being connected to the cathode at a side of the cathode layer facing away from the light emitting layer, and being configured for improving a resistance to buckling resulting from local heating of the cathode. At least part of the light emitting layer has reduced light emitting properties through the application of light.

An OLED for light-induced patterning which is patterned according to a suitable light-induced patterning method can be manufactured faster due to the higher light intensity which may be used. That is, the patterning costs of such patterned OLEDs are lower.

In a further aspect of the invention, a light source comprises a patterned OLED according to the invention. For example, in an embodiment, a lamp comprises a patterned OLED according to the invention.

An organic light emitting diode (OLED) for light-induced patterning is presented. The OLED comprises a buckling-reducing layer connected to a cathode layer at a side of the cathode layer facing away from a light emitting layer. The buckling reducing layer is configured for improving a resistance to buckling resulting from local heating of the cathode, which heat may be caused by patterning the OLED. The buckling reducing layer improves mechanical properties, e.g., stiffness, and/or thermal properties, e.g. through cooling, of the cathode.

It is to be noted that patent application, ‘Patterned OLED device, method of generating a patterning, system for patterning and method of calibrating the system’, with attorney docket PH012033, incorporated herein by reference, describes a patterned light emitting diode device. The patterned organic light emitting diode device comprises organic light emitting material arranged between an anode layer and a cathode layer and further comprises at least one current support layer for enabling a current flowing, in operation, through the light emitting material to cause the light emitting material to emit light. Part of the current support layer is patterned by locally altering a current support characteristic, while not substantially altering the organic light emitting material, the anode layer, and the cathode layer. The current support characteristic locally determines the current flowing through the organic light emitting material in operation. By altering the current support characteristic, a pattern may be created in the organic light emitting diode device which is substantially not visible in an off-state of the organic light emitting diode device, and which is clearly visible as light intensity variations in an on-state of the organic light emitting diode device.

Modifying current support layers is particularly effective for oligomer-based OLEDs. For polymer based OLEDs, it is preferred to modify the light emitting material itself through light irradiation. Such devices may not have a current support layer, and it may be slightly visible in an off-state of the device that the OLED is patterned.

### BRIEF DESCRIPTION OF THE DRAWINGS

The invention is explained in further detail by way of example and with reference to the accompanying drawings, wherein:

FIG. 1a is a schematic cross-sectional view of an organic LED device according to the invention,

FIG. 1b is a schematic cross-sectional view of the light emitting layer of an organic LED device according to the invention,

FIG. 2 is a schematic cross-sectional view of a further organic LED device according to the invention.

Throughout the Figures, similar or corresponding features are indicated by same reference numerals.

### LIST OF REFERENCE NUMERALS

100 an OLED
110 a substrate
120 an anode
130 a light emitting layer
132 a conductive layer
134 an emissive layer
140 a cathode
150 a buckling-reducing layer
160 a light emission direction
165 pattern inducing light
200 an OLED
260 a lighting direction
265 a pattern inducing direction

### DETAILED EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

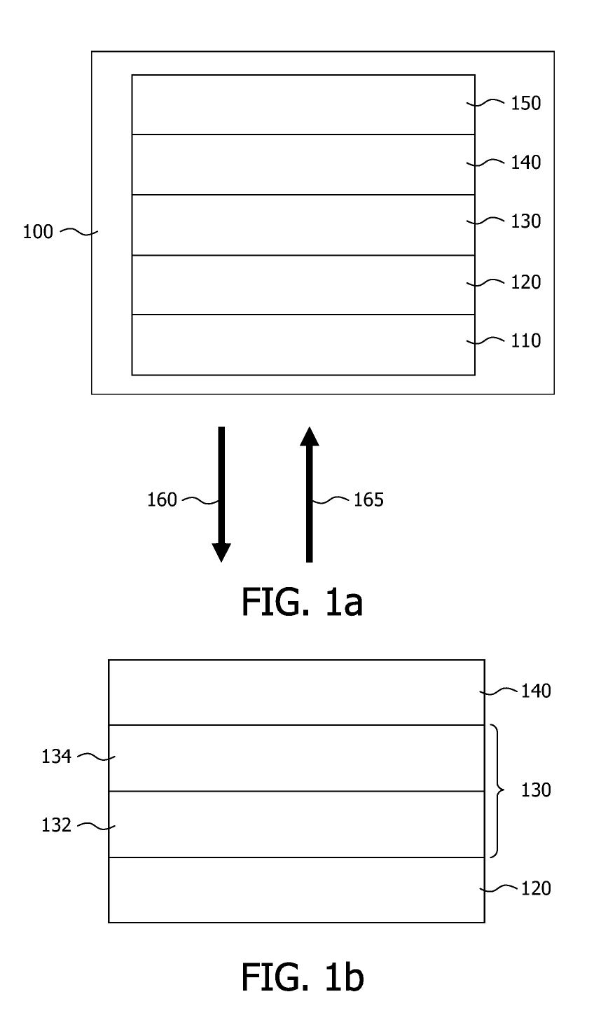

FIG. 1a shows a cross-sectional view of an organic LED device 100 according to an embodiment of the present invention. OLED 100 comprises a substrate 110 on which are applied, in order, an anode 120, a light emitting layer 130, a cathode 140 and a buckling-reducing layer 150. Anode 120 may for instance comprise Indium tin-oxide (ITO), fluoridated Zinc-oxide, PEDOT, or any other suitable anode material. A voltage can be applied over cathode 140 and anode 120, resulting in a current flow through light emitting layer 130. FIG. 1b shows light emitting layer 130 in more detail, it comprises a conductive layer 132 and an emissive layer 134, wherein the conductive layer 132 is towards the side of the anode 120 and the emissive layer 134 towards the cathode 140. According to the art of OLEDs, intermediate layers may be present in the OLED. For example, current support layers may be present between anode 120 and cathode 140.

Conductive layer 132 and emissive layer 134 may be manufactured of an organic material such as a polymer or an oligomer. Light emitting layer 130 may comprise materials with low molecular weight, so-called small-molecule (SM) OLED. The deposition of SM-OLEDs is typically based on vacuum thermal evaporation. Light emitting layer 130 may also be polymer based (PLEDs), comprising long polymer organic chains, which may be deposited by spin-cast or ink-jet principles.

In order for OLED 100 to function properly and for protection from moisture and contamination from, for instance, dust and small particles, the OLED 100 can be encapsulated with an encapsulating body (not shown) such as an encapsulating lid. When a voltage is applied, electrons and holes recombine in organic light emitting layer 130 which causes light to be emitted from the OLED 100. The light can, for instance, be emitted via the anode 120, in which case anode 120 is at least partially transparent to the generated light. Light emitted through anode 120 is shown in FIG. 1a as light emission direction 160.

Cathode 140 may also be transparent. Substrate 110 may also be transparent. For example, Substrate 110 may be made of glass.

OLED 100 may be patterned by irradiating with pattern inducing light 165. A light beam 165 irradiates OLED 100 causing the light emitting properties of light emitting layer 130 to be altered in the irradiated areas. Light beam 165 may, e.g., pass through substrate 110 and anode 120 to affect the light emitting layer 130. Pattern inducing light 165 may have a wavelength in the absorption band of light emitting layer 130, in one embodiment avoiding wavelengths below 400 nm. The photo-induced process in light emitting layer 130 causes a reduction of the original light emission in the irradiated areas of light emitting layer 130, allowing a pattern to be visible when OLED 100 is switched to its on-state. In FIG. 1a, the pattern inducing light 165 reaches the light-emitting layer 130, through the substrate 110 and anode 120, which are for that purpose at least partially transparent to the patterning light 165. Alternatively, the light-emitting layer 130 may be reached through the buckling reducing layer 150, and the cathode 140. In the latter situation, the buckling reducing layer 150 and the cathode 140 are at least partially transparent.

In one embodiment, pattern inducing light 165 is laser light. OLED 100 can, for instance, be a known super-yellow device of bottom emission type, on a 0.5 mm soda-lime glass substrate, on which a buckling reducing layer is deposited. Pattern inducing light 165 may be generated by a frequency doubled Nd:YAG laser (532 nm wavelength).

In one embodiment, OLED 100 comprises a blue-emitting polymer. Pattern inducing light 165 may have a wavelength of 405 nm. In this case, a low-price solid state diode laser as used in Blue-ray disc products may be used.

During light-induced patterning, condensed light impinges on the light emitting layer for altering its light emissive properties. At least part of that light also reaches the cathode layer and impinges upon it, e.g., because some part of the light transmits through the light emissive layer. Due to partial absorption of this impinging light the cathode is heated.

Buckling-reducing layer 150 is connected to cathode 140 to mitigate the deforming effects due to local heating. The buckling threshold defines an amount of supplied energy above which buckling of the cathode layer occurs, if said amount is applied to the cathode layer during the light-induced patterning, e.g., during some pre-determined time period or at a pre-determined scanning speed of the pattern inducing light. The buckling threshold may also be expressed as a temperature increase of the cathode layer, above which buckling occurs. Buckling-reducing layer 150 can delay the onset of buckling by increasing the buckling threshold.

Moreover, even if buckling occurs then buckling-reducing layer 150 assists in controlling it, i.e., reducing its severity. Preferably, the thermal and/or mechanical connection between buckling-reducing layer 150 and cathode 140 is relatively strong and has a relatively high adhesion. Buckling-reducing layer 150 can help resist deformation by increasing the stiffness of the cathode 140 and/or transporting at least part of the heat applied to cathode 140 away from it.

For example, the connection between buckling-reducing layer 150 and cathode 140 may be chosen such that some of the forces which are caused in cathode 140 by the heat are at least in part resisted by virtue of being connected to buckling-reducing layer 150. In other words, buckling-reducing layer 150 may act as a kind of skeleton for cathode 140. The stiffness of buckling-reducing layer 150 may be expressed in terms of its Young's modulus E. An improvement of the buckling resistance of cathode 140 has already been observed from an E value of the buckling reducing layer of 50 GPa. However, Young's modulus of buckling-reducing layer 150 is preferably greater than 100 GPa and more preferably greater than 250 GPa. Choosing materials with a high mechanical stiffness level for the buckling-reducing layer, in particular, higher than the mechanical stiffness level of the cathode layer, is an efficient way to increase the stiffness of cathode 140, especially when combined with a strong mechanical connection.

It is advantageous if buckling-reducing layer 150 itself does not deform strongly in response to heat. The thermal expansion coefficient of buckling-reducing layer 150 is therefore preferably small, e.g., smaller than 30 ppm/K (=10⁻⁶/K), and preferably smaller than 10 ppm/K. If buckling-reducing layer 150 has a relatively low thermal expansion coefficient, e.g., lower than the thermal expansion coefficient of the cathode layer, then deformation in cathode 140 is resisted as well, especially when the connection comprises a mechanical connection.

As a further example, buckling-reducing layer 150 can also help resist deformation by transporting at least part of the thermal energy applied to cathode 140 away from it. The connection between cathode 140 and buckling-reducing layer 150 may comprise a thermal connection for transporting heat from cathode 140 to at least part of buckling-reducing layer 150. As the heat is transported away, the buckling onset will be delayed. Moreover, after the onset of buckling, the buckling will proceed slower, since some of the heat is transported away. Preferably, the buckling-reducing layer has a heat capacity so that some of the heat which is transferred from the cathode layer 140 to the buckling reducing layer 150 may be absorbed by the buckling reducing layer 150, during the light-induced patterning of the OLED. This further increases the buckling threshold. Preferably, the layer's thermal capacity is greater than 2 J/cm³/K, and the layer has a high thermal conductivity. A relatively high thermal conductivity allows the heat energy which is absorbed locally to be transferred to other parts of the buckling reducing layer which are currently irradiated by the patterning light. In this way, the thermal conductivity assists in spreading the heat energy over a larger area of the buckling reducing layer. As a result, the overall temperature increase will be reduced and thus the capacity of the buckling reducing layer for cooling the cathode layer is increased. Moreover, if the heat is spread over a larger area, then the buckling reducing layer itself can also dissipate its heat-energy more easily.

A further heat sink (not shown) may be connected to cathode 140, via buckling-reducing layer 150.

It has been observed that the above mentioned effects markedly increase with the layer thickness of buckling-reducing layer 150. The layer thickness of buckling-reducing layer 150 is preferably greater than 20 nm, or greater than 50 nm or greater than 100 nm. Although it is preferred that buckling-reducing layer 150 is a separate layer from cathode 140, it has been observed that an increase in buckling resistance can be achieved by increasing the thickness of cathode 140 itself, without using a separate buckling-reducing layer. For example, one embodiment of such OLED is an OLED comprising a stack of layers, the stack comprising a light emitting layer arranged between a cathode layer and an anode layer, the stack being arranged on a substrate, wherein part of the light emitting layer has locally reduced light emitting properties constituting a pattern, which pattern is preferably light, e.g., laser, induced, and wherein the cathode layer has a thickness for improving a resistance to buckling resulting from local heating of the cathode. The cathode preferably comprises aluminum, and may even consist of an aluminum alloy. A thicker layer, e.g. metal layer, has at least two advantages: enhanced cooling of the cathode due to increased heat sinking capacity, and increased stiffness of the cathode. Both aspects help preventing the occurrence and extent of buckling during laser irradiation for patterning the OLED. In this way, the cathode has a higher resistance to buckling resulting from local heating of the cathode. Buckling of thicker materials produces less visible wrinkles in the material. Therefore, apart from making the cathode more robust against buckling, the thicker layer, makes buckling also less visible if it occurs. It is also shown that higher contrasts in the pattern can be achieved. Moreover, higher patterning speeds and higher light power can be used, which decreases production time. Preferably cathode 140 has a thickness of at least 100 nm, or greater than 150 nm, or greater than 200 nm.

It has been observed that in this range the maximum light output of a patterning laser without buckling increases approximately proportionally with the thickness of cathode 140 and/or buckling-reducing layer 150.

Example materials for buckling-reducing layer 150 include various metals, including aluminum alloys, molybdenum, copper, and tungsten. These have a relatively large Young's Modulus and relatively small thermal expansion. Alternatively, silicon is suited as well. Silicon has similar properties as the mentioned metals, moreover it has a relatively low expansion. Glass, glass-like and ceramic materials are also possible, in particular solgel materials which can be applied to cathode 140 in liquid form before curing.

Preferred materials further include dielectrics, such as AlNx, SiNx, SiN:H, AlOx, ALONx, etc. These materials have a relatively very large Young's Modulus and relatively small thermal expansion. Moreover, they can be readily deposited at high rates and at low cost in a normal production line as compared to the metal electrode deposition. Using these materials for buckling-reducing layer 150 is therefore advantageous for fabrication, as they lower the time needed for apply the buckling reducing layer.

Some example values of Young's elastic modulus (GPa) for various materials: Al 69, glass 65-90, Cu 120, W 400, SiNx ˜300, AlOx ˜300; and of the thermal expansion (10⁻⁶/K): Al 23, glass 3-8.5, Si 3, Mo 4.8, AlOx 6, SiN 2.5;

For transporting thermal energy, buckling-reducing layers comprising metal are preferable, for example, using copper, aluminum and alloys comprising them. Also suitable are molybdenum and tungsten, which have advantageously a relatively low thermal expansion coefficient and high E modulus. Furthermore, silicon even in amorphous form is advantageous. Apart from the transparency, the glass-like and dielectric materials are particularly suitable for their high E modulus. MN is suitable for its high conductivity.

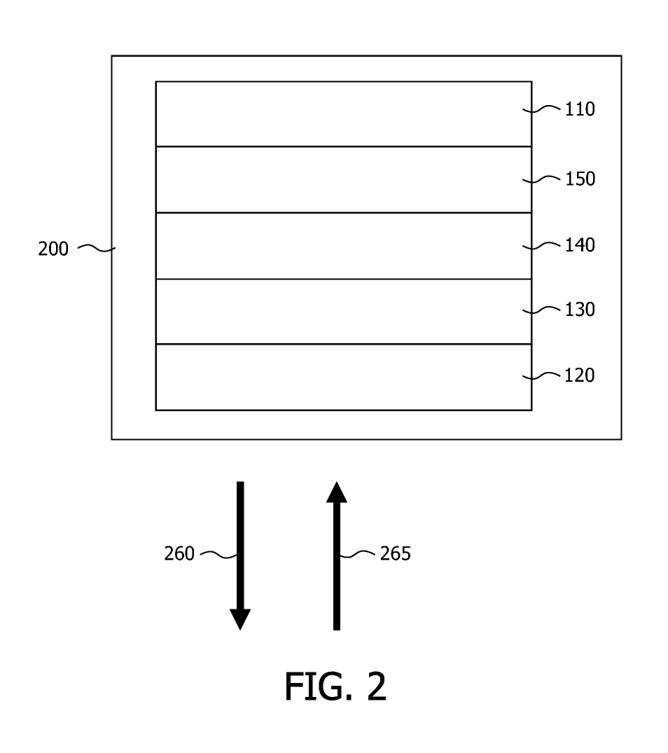

The stack of the anode layer 120, light emitting layer 130 and cathode layer 140 can be placed on substrate 110 either with the cathode layer 140 towards substrate 110 or with the anode layer 120 towards substrate 110. Shown in FIG. 2, is OLED 200, which has an alternative placement of the layers. FIG. 2 shows a substrate 110 on which is arranged, in order, the buckling-reducing layer 150, the cathode 140, the light emitting layer 130, and the anode 120.

The arrangement in FIG. 2 is suitable for top-emission. In FIG. 2, light is emitted in a direction 260 and transmitted through anode 120, which is at least partially transparent to the emitted light. Applying the pattern may be done by a condensed light beam in a pattern inducing direction 265, that is, not through the substrate. In case substrate 110 is transparent to the used patterning light, it may also be done through substrate 110.

When patterning is done through the substrate 110, a transparent cathode may be used, such as thin silver layer. The silver layer has a thickness of preferably less than 20 nm. Transparent cathodes are particularly vulnerable to buckling during the patterning. Part of the light impinging on the cathode is absorbed by the cathode layer causing local temperature rise, and eventually buckling. Because of buckling-reducing layer 150, the cathode 140 is protected from buckling along the same principles as explained for FIG. 1a. Preferably, when a, at least partially, transparent cathode is used, also a, at least partially, transparent buckling-reducing layer 150 is used. Suitable materials for a transparent buckling-reducing layer 150 include glass, transparent Silicon, Nitride, transparent Aluminum Oxide, etc (see above).

It is observed that in the arrangement of FIG. 2 that buckling is more problematic if the substrate 110 is of a material with a low Young's modulus, such as plastic. For the production of flexible devices, materials like PET or PEN can be used. These have E values in the range of 6 GPa, about an order of magnitude smaller than glass. To prevent moisture degradation of the OLED, barrier layers are typically applied on these substrates. One approach is to use a layer stack comprising, e.g., acrylic polymers in combination with thin inorganic layers. These polymer materials have even lower E values, ranging from about 40 MPa up to 3 GPa.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. An OLED for light-induced patterning comprising a stack of layers, the stack comprising a light emitting layer arranged between a cathode layer and an anode layer, the stack being arranged on a substrate, the OLED further comprising a buckling-reducing layer, not-being the substrate, the buckling-reducing layer being connected to the cathode at a side of the cathode layer facing away from the light emitting layer, and being configured for improving a resistance to buckling resulting from local heating of the cathode.

2. An OLED as in claim 1, wherein the buckling-reducing layer and said connection to the cathode are configured for increasing a buckling threshold of the cathode layer, the buckling threshold defining an amount of heat above which buckling of the cathode layer occurs, if said amount is applied to the cathode layer during the light-induced patterning.

3. An OLED as in claim 1, wherein the connection between the buckling-reducing layer and the cathode layer comprises a mechanical connection for increasing a mechanical stiffness level of the cathode layer.

4. An OLED as in claim 3 wherein the increase in mechanical stiffness level is substantially in a direction parallel to the cathode layer.

5. An OLED as in 3, wherein a mechanical stiffness level of the buckling-reducing layer is higher than the mechanical stiffness level of the cathode layer.

6. An OLED as in claim 1, wherein the connection between the buckling-reducing layer and the cathode layer comprises a thermal connection for transporting heat from the cathode layer to at least part of the buckling-reducing layer.

7. An OLED as in claim 6, wherein the buckling reducing layer and the thermal connection to the cathode layer are configured to increase the buckling threshold by transporting heat to limit the local heating of the cathode layer during the light-induced patterning of the OLED.

8. An OLED as in claim 6, wherein the buckling-reducing layer and the thermal connection between the buckling-reducing layer and the cathode layer is configured for transporting heat away from the cathode layer to a further heat sink.

9. An OLED as in claim 6, wherein the buckling-reducing layer comprises a heat capacity for absorbing heat to limit the local heating of the cathode layer during the light-induced patterning of the OLED to increase the buckling threshold.

10. An OLED as in claim 1, wherein the buckling reducing layer comprises at least one material out of the following list of materials: Aluminum Nitride, Silicium Nitride, SiNx:H, Aluminum Oxide, Aluminum oxynitride, silicon oxide, silicon oxynitride.

11. An OLED as in claim 1, wherein the cathode layer and the buckling reducing layer are at least partially transparent to visible light.

12. An OLED as in claim 11, wherein the buckling-reducing layer comprises at least one material out of the following list of materials: solgel, spin-on glass or epoxy, Aluminum Nitride, Silicium Nitride, SiNx:H, Aluminum Oxide, Aluminum oxynitride, silicon oxide, silicon oxynitride.

13. A patterned OLED as in claim 1, wherein part of the light emitting layer has locally reduced light emitting properties constituting a pattern.

14. A light source comprising an OLED as in claim 13.
